(19) United States
(12) Patent Application Publication
(10) Pub. No.: US 2023/0125542 A1
(43) Pub. Date: Apr. 27, 2023

(54) METHOD AND SYSTEM OF INITIATING SIMULTANEOUS START OF BLOCK FORMATION

(71) Applicant: MASTERCARD INTERNATIONAL INCORPORATED, Purchase, NY (US)

(72) Inventors: Ankur ARORA, New Delhi (IN); Jaipal Singh KUMAWAT, Sikar, Rajasthan (IN); Chandan GARG, Gurgaon, Haryana (IN)

(73) Assignee: MASTERCARD INTERNATIONAL INCORPORATED, Purchase, NY (US)

(21) Appl. No.: 17/508,048

(22) Filed: Oct. 22, 2021

(51) Int. Cl. G06F 16/23; H04L 9/32

(52) U.S. Cl. CPC G06F 16/2379; H04L 9/3236

(57) ABSTRACT

The present disclosure provides a description of exemplary systems and methods for initiating a simultaneous start of block formation in a distributed ledger. The methods and systems may include a processor which may receive a base key. The base key may be generated by the distributed ledger at a time of validation of a first hash for a first block of transactions. The processor may generate a second hash for a second block of transactions to be added to the distributed ledger using the base key as an input for the second hash. The processor may transmit the second hash having the base key as an input to a plurality of second processors.

### TECHNICAL FIELD

The present disclosure generally relates to block formation in a distributed ledger, specifically to the initiation of block formation in a distributed ledger.

### BACKGROUND

Blockchain was initially created as a storage mechanism for use in conducting payment transactions with a cryptographic currency. Using a blockchain can provide a number of benefits, such as decentralization, distributed computing, transparency regarding transactions, and yet also providing the possibility anonymity as to the individuals or entities involved in a transaction. New blocks are added to the blockchain through a process known as “consensus.” In a traditional consensus process, blockchain nodes work to generate a new block that satisfies all requirements, a process known as “mining,” and then will share the new block with other nodes. The other nodes will confirm that the block is suitable and then distribute the block throughout the blockchain, which effectively adds that block into the blockchain and moves the nodes on to working on consensus on the next block.

### SUMMARY

The present disclosure provides a description of exemplary systems and methods for initiating a simultaneous start of block formation in a distributed ledger. The methods and systems may include a processor which may receive a base key. The base key may be generated by the distributed ledger at a time of validation of a first hash for a first block of transactions. The processor may generate a second hash for a second block of transactions to be added to the distributed ledger using the base key as an input for the second hash. The processor may transmit the second hash having the base key as an input to a plurality of second processors. The processor may receive a validation of the second hash for the second block of transactions. The validation may be based on a consensus of the plurality of second processors and the consensus may further be based on the plurality of second processors verifying the base key.

The present disclosure also provides a description of a method for initiating a simultaneous start of block formation in a distributed ledger, the method includes: receiving, by the first computing device, a base key, the base key being generated by the distributed ledger at a time of validation of a first hash for a first block of transactions; and generating, by the first computing device, a second hash for a second block of transactions to be added to the distributed ledger using the base key as an input for the second hash.

The present disclosure further provides a description of a system for initiating a simultaneous start of block formation in a distributed ledger, the system including: one or more processors, one or more computer-readable memories, one or more computer-readable tangible storage devices, and instructions stored on at least one of the one or more storage devices for execution by at least one of the one or more processors via at least one of the one or more memories, the instructions include: instructions to receive, by the first computing device, a base key, the base key being generated by the distributed ledger at a time of validation of a first hash for a first block of transactions; and instructions to generate, by the first computing device, a second hash for a second block of transactions to be added to the distributed ledger using the base key as an input for the second hash.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for initiating a simultaneous start of block formation in a distributed ledger in accordance with exemplary embodiments.

FIG. 2 is a block diagram illustrating a simplified blockchain in accordance with exemplary embodiments.

FIG. 3 is a block diagram illustrating a computing system of the system of FIG. 1 for initiating a simultaneous start of block formation in a distributed ledger in accordance with exemplary embodiments.

FIG. 4 is a flow chart illustrating exemplary methods for initiating a simultaneous start of block formation in a distributed ledger in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain— A public ledger of all transactions of a blockchain-based currency or network. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof-of-work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

In current distributed ledger technologies, miner nodes within a blockchain network compete against each other to solve a complex mathematical problem by generating a hash within a defined set of parameters for a block of transactions selected from a memory pool. The miner node that transmits a correct hash for the selected block of transactions to the network, e.g., the other nodes in a blockchain network, and receives consensus, e.g., fifty-one percent of the network validates the hash, wins and the block mined by that miner node is added onto the blockchain. Currently, in order to generate a hash for a block of transactions, the miner nodes must use various inputs such as, but not limited to, the Merkle root of the transactions being mined, the hash of the previous block's header, i.e., the header of the previous block in the blockchain, and a nonce value, etc. In current blockchain systems, miner nodes with greater computing power than other mining nodes have an advantage since they are able to run hashing computations at a much faster rate than nodes with less computing power. Therefore, in current systems, a powerful miner node may mine a first block of transactions very quickly and use that block to mine a second block of transactions without broadcasting the first block to the rest of the network. Further, the second block mined may be an empty block, which is a block that has only one transaction—the blockchain network transaction awarding the miner a mining reward for that block. Thus, current systems provide an unfair advantage to powerful miner nodes.

The methods and systems herein provide a novel solution, not addressed by current technology, to prevent certain miner nodes from mining a second block before broadcasting and receiving consensus on a first block. Exemplary embodiments of the methods and systems provided for herein utilize a base key which must be used in generating the hash for a block of transactions to be added to a distributed ledger. The base key is generated by the distributed ledger only once a block has achieved consensus in the distributed ledger network; therefore, miner nodes cannot begin mining a block of transactions until the previous block has been added to the distributed ledger. Further, the methods and systems herein provide a novel solution, not addressed by current technology, to prevent branching of the blockchain, e.g., when two or more miner nodes transmit a correct hash for a block of transactions in close proximity of each other resulting in two or more valid branches of the blockchain. Thus, the methods and systems provided for herein provide for a fair mining in a distributed ledger in which all miner nodes must begin mining a particular block at the same time.

### System for Initiating a Simultaneous Start of Block Formation in a Distributed Ledger

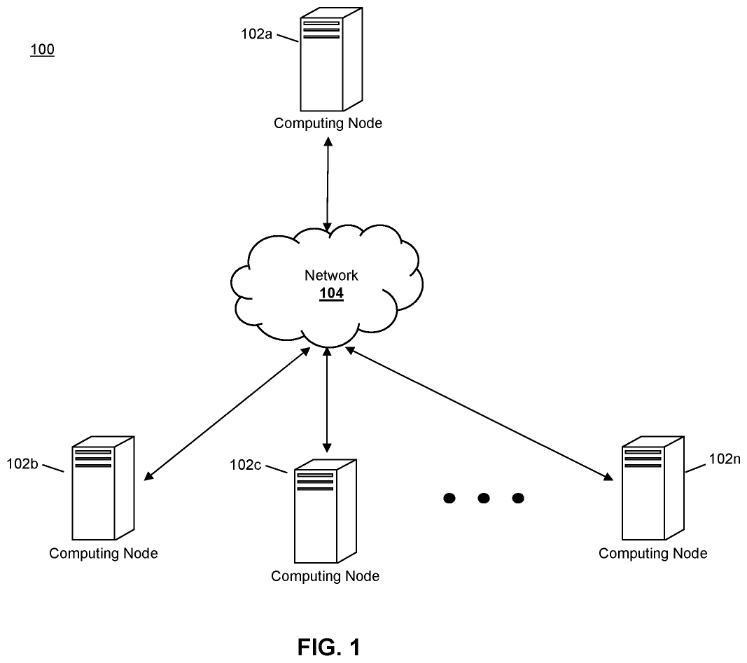

FIG. 1 illustrates a system 100 for initiating a simultaneous start of block formation in a distributed ledger.

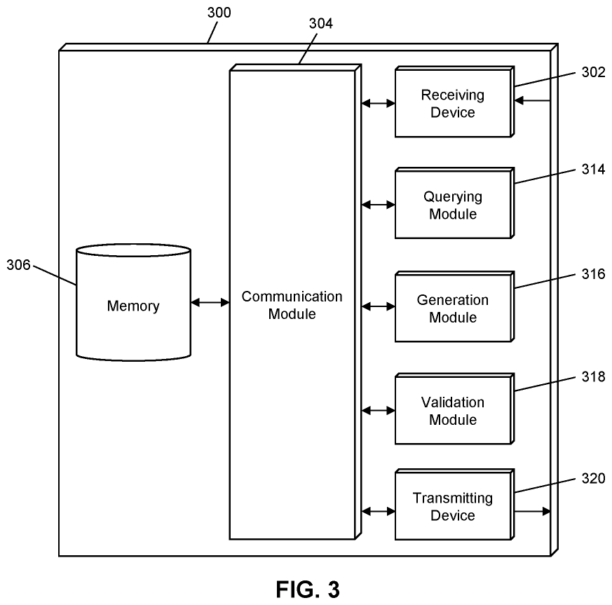

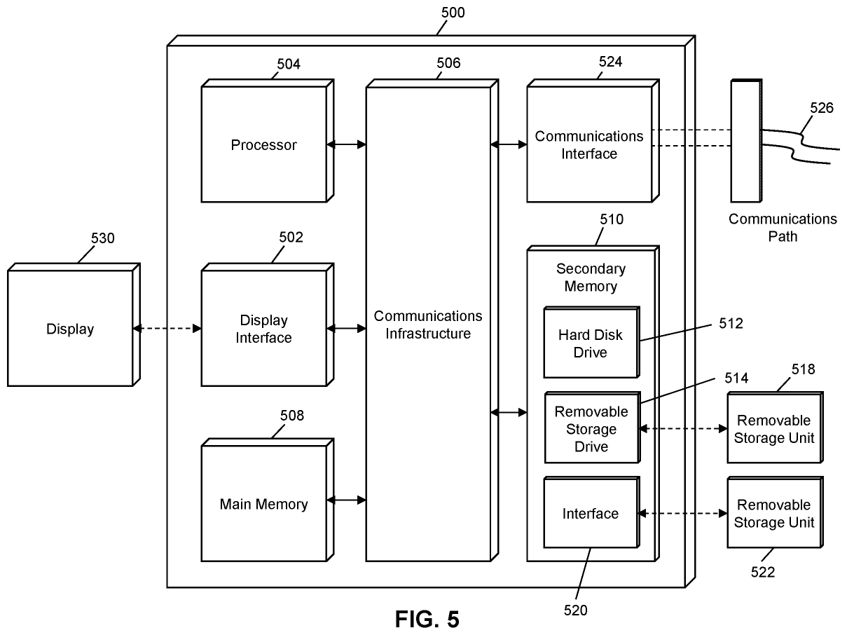

In the system 100, computing nodes 102a-n may communicate via a network 104. The computing nodes 102a-n may be any type of computing system that is specially configured to perform the functions discussed herein, such as the computing system 300 illustrated in FIG. 3 or the computing system 500 illustrated in FIG. 5, as discussed in more detail below. Further, it can be appreciated that the computing nodes 102a-n may include one or more computing devices.

In the system 100, the network 104 may be the Internet, representing a worldwide collection of networks and gateways to support communications between devices connected to the Internet. The network 104 may include, for example but not limited to, wired, wireless or fiber optic connections and mixtures thereof. In other embodiments, the network 104 may be implemented as an intranet, a local area network (LAN), a wide area network (WAN), or a personal area network (PAN). In general, the network 104 can be any combination of connections and protocols that will support communications between the computing nodes 102a-n.

In an exemplary embodiment, the computing nodes 102a-n may be part of a distributed ledger network, such as, but not limited to, a blockchain network. While reference is made throughout to a blockchain network, it can be appreciated that the methods and systems discussed herein may be executed using any distributed ledger network that utilizes miner nodes to mine blocks of transactions to be added to the distributed ledger.

In an exemplary embodiment of the system 100, the computing nodes 102a-n are miner nodes in a blockchain network, e.g., the network 104. Miner nodes are computing nodes within a blockchain network, e.g., the computing nodes 102a-n, that compete against each other to solve a complex mathematical problem by generating a hash within a defined set of parameters for a block of transactions selected from a memory pool. The miner node that transmits a correct hash for the selected block of transactions to the network, e.g., the other nodes in a blockchain network, and receives consensus, e.g., fifty-one percent or more of the network validates the hash, wins and the block mined by that miner node is added onto the blockchain.

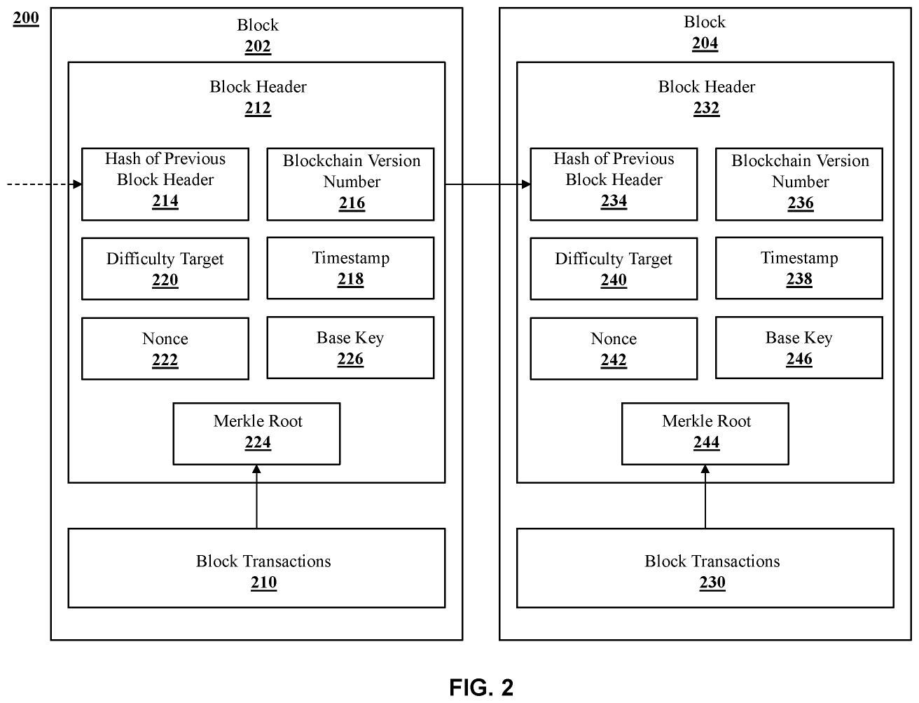

FIG. 2 illustrates an example of two blocks in a blockchain 200 in accordance with exemplary embodiments of the system 100. In the blockchain 200, each block, e.g., the block 202, 204, of the blockchain 200 contains a block of transactions, e.g., the block transactions 210, 230, and a corresponding block header, e.g., the block header 212, 232. The block headers, e.g., the block header 212, 232, identify a particular block in the blockchain, e.g., the block 202, 204. Further, the block headers 212, 232, include data which is hashed repeatedly by the miner nodes, e.g., the computing nodes 102a-n, to produce a proof-of-work for the block transactions, e.g., the block transactions 210, 230. The block headers 212, 232 include various data such as, but not limited to, a hash of the previous block's header, e.g., the hash of previous block header 214, 234, a blockchain version number, e.g., the blockchain version number 216, 236, a timestamp, e.g., the timestamp 218, 238, a difficulty target, e.g., the difficulty target 220, 240, a nonce, e.g., the nonce 222, 242, and a Merkle root of the transactions being mined, e.g., the Merkle root 224, 244. In an exemplary embodiment of the system 100, a block header, e.g., the block headers 212, 232, will also include a base key, e.g., the base key 226, 246. A hash of the previous block's header, e.g., the hash of previous block header 214, 234, is the hash of the block header that immediately precedes a current block. For example, the block header 232 would include a hash of the block header 212. Further, the hash of previous block header 214, 234 may be the block header that immediately precedes a current block run through a hashing algorithm twice, e.g., SHA-256; thus linking each block to the one that precedes it. A blockchain version number, e.g., the blockchain version number 216, 236, indicates the version of the blockchain protocol rules used to create the block. A timestamp, e.g., the timestamp 218, 238, indicates an approximate time when the block was created. For example, the timestamp 218, 238, may be the time the blockchain network achieved consensus for the block 202, 204. A difficulty target, e.g., the difficulty target 220, 240, sets how difficult a block of transactions, e.g., block transactions 210, 230, is to mine. For example, the difficulty target may require a hash of the block transactions 210, 230 to start with certain number of zeroes. A nonce, e.g., the nonce 222, 242, is a random number appended to the hash of the block of transactions 210, 230 used to achieve the difficulty target. A Merkle root, e.g., the Merkle root 224, 244, of the blocks of transactions, e.g., the block transactions 210, 230 is found by hashing each transaction in a block of transactions, pairing the hashed transactions, then hashing and pairing over and over until a single hash remains, i.e., the Merkle root. For example, the block transactions 210 may include four transactions for ease of explanation; the four transactions would be hashed and then paired resulting in two pairs, the two pairs would be hashed and then paired together and hashed again resulting in a single hash for the four transactions, i.e., the Merkle root for the four transactions.

A base key, e.g., the base key 226, 246, is a value generated by the blockchain network once a block, e.g., the block 202, 204, is added to the blockchain for use as an input in the next block's header. For example, the base key 246 in the block header 232 of block 204 would be generated by the blockchain network only after block 202 has been added to the blockchain, e.g., once consensus has been reached for block 202. In an exemplary embodiment, a base key, e.g., the base key 226, 246, may be based on the timestamp, e.g., the timestamp 218, 238 of the previous block that was added to the blockchain. For example, the base key 246 in the block header 232 of block 204 would be based on the timestamp 218 in the block header 212 of the block 202. In another exemplary embodiment, a base key, e.g., the base key 226, 246, may be generated by the blockchain network using a formula programmed into the blockchain network protocols, which is executed once the previous block that is added to the blockchain. For example, the blockchain network may use any formula with various inputs to generate a random value to be used as the base key 226, 246. Therefore, a miner node can only begin to mine a block of transactions after the last block is added to the blockchain and the base key 226, 246 is generated by the blockchain network. Thus, the base key 226, 246 prevents a miner node from mining a block, appending that block to that miner node's ledger, and starting to mine the next block before broadcasting the first block to the other nodes in the blockchain network.

In an exemplary embodiment of the system 100, the computing node 102a receives a validation of a first hash, e.g., a consensus of the computing nodes 102a-n, for a first block transactions, e.g., the block transactions 210. The first block of transactions would be posted to the blockchain, e.g., as block 202, and a base key, e.g., the base key 246, is generated by the blockchain network. The computing node 102a receives the base key 246 generated by the blockchain network. The first computing node 102a generates a second hash for a second block of transactions, e.g., the block transactions 230, using the generated base key, e.g., the base key 246, as input for generating the second hash. The computing node 102a transmits the second hash to the blockchain network, e.g., the computing nodes 102a-n. The computing node 102a receives a validation of the second hash, e.g., a consensus of the computing nodes 102a-n, based on the computing nodes 102a-n verifying the base key 246. The block transactions 230 are posted to the blockchain as a block, e.g., the block 204, and the blockchain network generates the next base key based on the addition of the block 204 for use in mining the next block by the computing nodes 120a-n.

### Computing System

FIG. 3 illustrates an embodiment of a computing system 300, such as may serve as the computing nodes 102a-n in the system 100. It will be apparent to persons having skill in the relevant art that the embodiment of the computing system 300 illustrated in FIG. 3 is provided as illustration only and may not be exhaustive to all possible configurations of the computing system 300 specifically configured for performing the functions as discussed herein. For example, the computer system 500 illustrated in FIG. 5 and discussed in more detail below may be a suitable configuration of the computing system 300.

The computing system 300 may include a receiving device 302. The receiving device 302 may be configured to receive data over one or more networks via one or more network protocols. In some instances, the receiving device 302 may be configured to receive data from the computing nodes 102a-n and other systems and entities via one or more communication methods, such as radio frequency, local area networks, wireless area networks, personal area networks, cellular communication networks, Bluetooth, the Internet, etc. In some embodiments, the receiving device 302 may be comprised of multiple devices, such as different receiving devices for receiving data over different networks, such as a first receiving device for receiving data over a local area network and a second receiving device for receiving data via the Internet. The receiving device 302 may receive electronically transmitted data signals, where data may be superimposed or otherwise encoded on the data signal and decoded, parsed, read, or otherwise obtained via receipt of the data signal by the receiving device 302. In some instances, the receiving device 302 may include a parsing module for parsing the received data signal to obtain the data superimposed thereon. For example, the receiving device 302 may include a parser program configured to receive and transform the received data signal into usable input for the functions performed by the processing device to carry out the methods and systems described herein.

The receiving device 302 may be configured to receive data signals electronically transmitted by the computing nodes 102a-n that may be superimposed or otherwise encoded with one or more hashes for one or more block of transactions, which may include a base key used as input to generate the one or more hashes. The receiving device 302 may also be configured to receive data signals electronically transmitted by the computing nodes 102a-n, which may be superimposed or otherwise encoded with one or more consensus based validations of the one or more hashes generated by the computing nodes 102a-n.

The computing system 300 may also include a communication module 304. The communication module 304 may be configured to transmit data between modules, engines, databases, memories, and other components of the computing system 300 for use in performing the functions discussed herein. The communication module 304 may be comprised of one or more communication types and utilize various communication methods for communications within a computing device. For example, the communication module 304 may be comprised of a bus, contact pin connectors, wires, etc. In some embodiments, the communication module 304 may also be configured to communicate between internal components of the computing system 300 and external components of the computing system 300, such as externally connected databases, display devices, input devices, etc. The computing system 300 may also include a processing device. The processing device may be configured to perform the functions of the computing system 300 discussed herein as will be apparent to persons having skill in the relevant art. In some embodiments, the processing device may include and/or be comprised of a plurality of engines and/or modules specially configured to perform one or more functions of the processing device, such as a querying module 314, generation module 316, validation module 318, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing system 300 may also include a memory 306. The memory 306 may be configured to store data for use by the computing system 300 in performing the functions discussed herein, such as public and private keys, symmetric keys, etc. The memory 306 may be configured to store data using suitable data formatting methods and schema and may be any suitable type of memory, such as read-only memory, random access memory, etc. The memory 306 may include, for example, encryption keys and algorithms, communication protocols and standards, data formatting standards and protocols, program code for modules and application programs of the processing device, and other data that may be suitable for use by the computing system 300 in the performance of the functions disclosed herein as will be apparent to persons having skill in the relevant art. In some embodiments, the memory 306 may be comprised of or may otherwise include a relational database that utilizes structured query language for the storage, identification, modifying, updating, accessing, etc. of structured data sets stored therein. The memory 306 may be configured to store, for example, cryptographic keys, salts, nonces, communication information for the back-end system, etc.

The memory 306 may be configured to store a blockchain. As discussed above, the blockchain may be comprised of a plurality of blocks, where each block may be comprised of at least a block header and one or more data values. Each block header may include a time stamp, a block reference value referring to the preceding block in the blockchain, and a data reference value referring to the one or more data values included in the respective block. The memory 306 may also be configured to store any additional data that may be used by the computing system 300 in performing the functions discussed herein, such as transactions associated with the blockchain, communication data between the computing nodes 102a-n of the blockchain network, access data for providing access to the blockchain data by the computing nodes 102a-n, public keys corresponding to private keys provisioned to the computing nodes 102a-n for verification of digital signatures, etc.

The computing system 300 may include a querying module 314. The querying module 314 may be configured to execute queries on databases to identify information. The querying module 314 may receive one or more data values or query strings, and may execute a query string based thereon on an indicated database, such as the memory 306 of the computing system 300 to identify information stored therein. The querying module 314 may then output the identified information to an appropriate engine or module of the computing system 300 as necessary. The querying module 314 may, for example, execute a query on the memory 306 of the computing system 300 to identify one or more inputs to be included in the one or more hashes for one or more blocks of transactions. The querying model 314 may also, for example, execute a query on the memory 306 of the computing system 300 to identify a base key to be included with a block of transactions.

The computing system 300 may also include a generation module 316. The generation module 316 may be configured to generate data for use by the computing system 300 in performing the functions discussed herein. The generation module 316 may receive instructions as input, may generate data based on the instructions, and may output the generated data to one or more modules of the computing system 300. For example, the generation module 316 may be configured to generate a base key based on a block previously added to a distributed ledger to be used in mining a current block. Further, the generation module 316 may be configured to generate one or more hashes for one or more blocks of transactions.

The computing system 300 may also include a validation module 318. The validation module 318 may be configured to perform validations for the computing system 300 as part of the functions discussed herein. The validation module 318 may receive instructions as input, which may include data to be validated and/or data to be used in the validation. The validation module 318 may perform a validation as requested and may output a result of the validation to another module or engine of the computing system 300. The validation module 318 may, for example, be configured to verify a correct base key is used in a hash generated by the computing nodes 102a-n for a block of transactions. Further, the validation module 318 may, for example, be configured to validate and invalidate the one or more hashes generated by the computing nodes 102a-n for one or more blocks of transactions.

The computing system 300 may also include a transmitting device 320. The transmitting device 320 may be configured to transmit data over one or more networks via one or more network protocols. In some instances, the transmitting device 320 may be configured to transmit data to the computing nodes 102a-n, the network 104, and other entities via one or more communication methods, local area networks, wireless area networks, cellular communication, Bluetooth, radio frequency, the Internet, etc. In some embodiments, the transmitting device 320 may be comprised of multiple devices, such as different transmitting devices for transmitting data over different networks, such as a first transmitting device for transmitting data over a local area network and a second transmitting device for transmitting data via the Internet. The transmitting device 320 may electronically transmit data signals that have data superimposed that may be parsed by a receiving computing device. In some instances, the transmitting device 320 may include one or more modules for superimposing, encoding, or otherwise formatting data into data signals suitable for transmission.

The transmitting device 320 may be configured to electronically transmit data signals to the computing nodes 102a-n that are superimposed or otherwise encoded with one or more hashes for one or more block of transactions, which may include a base key used as input to generate the one or more hashes. The transmitting device 320 may also be configured to electronically transmit data signals to computing nodes 102a-n 102 that may be superimposed or otherwise encoded with one or more consensus based validations of the one or more hashes generated by the computing nodes 102a-n.

### An Exemplary Method for Initiating a Simultaneous Start of Block Formation in a Distributed Ledger

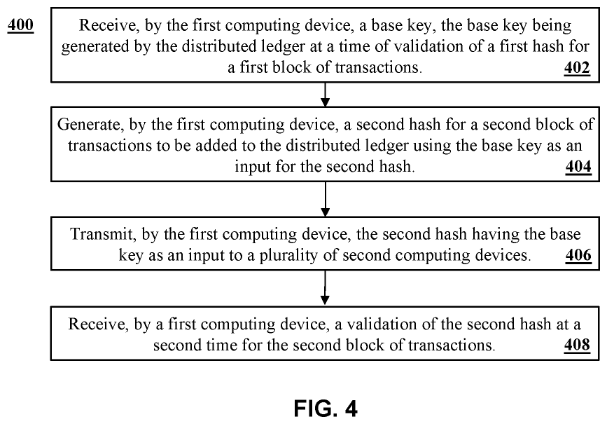

FIG. 4 illustrates a method 400 for initiating a simultaneous start of block formation in a distributed ledger in the perspective of the computing node 102a in the system 100 of FIG. 1.

In block 402, a first computing device, e.g., the computing node 102a, receives, e.g., via the receiving device 202, a base key, the base key generated by the distributed ledger at a time of validation of a first hash for a first block of transactions.

In block 404, the first computing device, e.g., the computing node 102a, generates, e.g., via the generation module 316, a second hash for a second block of transactions to be added to the distributed ledger using the base key as an input for the second hash.

In block 406, the computing device, e.g., the computing node 102a, transmits the second hash having the base key as an input to a plurality of second computing devices, e.g., the computing nodes 102b-n.

In block 308, the first computing device, e.g., the computing node 102a, receives, e.g., via the receiving device 202, a validation of the second hash for the second block of transactions. The validation being a consensus of the plurality of second computing devices, e.g., the computing nodes 102b-n. Further, the consensus of the plurality of second computing devices, e.g., the computing nodes 102b-n, is based on validating, e.g., via the validation module 318, the base key.

### Computer System Architecture

FIG. 5 illustrates a computer system 500 in which embodiments of the present disclosure, or portions thereof, may be implemented as computer-readable code. For example, the computing nodes 102a-n of FIG. 1 and the computing system 300 of FIG. 3 may be implemented in the computer system 500 using hardware, software executed on hardware, firmware, non-transitory computer readable media having instructions stored thereon, or a combination thereof and may be implemented in one or more computer systems or other processing systems. Hardware, software, or any combination thereof may embody modules and components used to implement the methods of FIG. 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIG. 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for authentication of a client device using a hash chain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for initiating a simultaneous start of block formation in a distributed ledger, the method comprising:
receiving, by the first computing device, a base key, the base key being generated by the distributed ledger at a time of validation of a first hash for a first block of transactions; and
generating, by the first computing device, a second hash for a second block of transactions to be added to the distributed ledger using the base key as an input for the second hash.

2. A method as in claim 1, further comprising:
transmitting, by the first computing device, the second hash having the base key as an input to a plurality of second computing devices; and
receiving, by a first computing device, a validation of the second hash for the second block of transactions.

3. A method as in claim 2, wherein the validation is based on a consensus of the plurality of second computing devices, the consensus being based on the plurality of second computing devices verifying the base key.

4. A method as in claim 1, wherein the base key is generated based on a timestamp of the first block of transactions.

5. A method as in claim 1, wherein the base key is generated by a formula programmed into a protocol of the distributed ledger network.

6. A method as in claim 1, wherein the first block of transactions immediately precedes the second block of transaction on the distributed ledger.

7. A method as in claim 1, wherein the base key is part of a block header for the second block of transactions.

8. A system for initiating a simultaneous start of block formation in a distributed ledger, the system comprising:
one or more processors, one or more computer-readable memories, one or more computer-readable tangible storage devices, and instructions stored on at least one of the one or more storage devices for execution by at least one of the one or more processors via at least one of the one or more memories, the instructions comprising:
instructions to receive, by the first computing device, a base key, the base key being generated by the distributed ledger at a time of validation of a first hash for a first block of transactions; and
instructions to generate, by the first computing device, a second hash for a second block of transactions to be added to the distributed ledger using the base key as an input for the second hash.

9. A system as in claim 8, further comprising:
instructions to transmit, by the first computing device, the second hash having the base key as an input to a plurality of second computing devices; and
instructions to receive, by a first computing device, a validation of the second hash for the second block of transactions.

10. A system as in claim 9, wherein the validation is based on a consensus of the plurality of second computing devices, the consensus being based on the plurality of second computing devices verifying the base key.

11. A system as in claim 8, wherein the base key is generated based on a timestamp of the first block of transactions.

12. A system as in claim 8, wherein the base key is generated by a formula programmed into a protocol of the distributed ledger network.

13. A system as in claim 8, wherein the first block of transactions immediately precedes the second block of transaction on the distributed ledger.

14. A system as in claim 8, wherein the base key is part of a block header for the second block of transactions.
